(19) United States
(12) Patent Application Publication
(10) Pub. No.: US 2025/0115083 A1
(43) Pub. Date: Apr. 10, 2025

(54) STRAIN DETECTION DEVICE

(71) Applicant: HITACHI ASTEMO, LTD., Hitachinaka-shi, Ibaraki (JP)

(72) Inventors: Kenji YOSHIHARA, Hitachinaka-shi, Ibaraki (JP); Hiroyuki ABE, Hitachinaka-shi, Ibaraki (JP); Fumio YUKI, Hitachinaka-shi, Ibaraki (JP); Takeo HOSOKAWA, Hitachinaka-shi, Ibaraki (JP)

(73) Assignee: HITACHI ASTEMO, LTD., Hitachinaka-shi, Ibaraki (JP)

(21) Appl. No.: 18/729,203

(22) PCT Filed: Feb. 22, 2022
(86) PCT No.: PCT/JP2022/007188

§ 371 Date: Jul. 16, 2024

(51) Int. Cl. B60C 23/06

(52) U.S. Cl. CPC B60C 23/064

(57) ABSTRACT

The present disclosure provides a strain detection device capable of downsizing and improvement in strain detection accuracy as compared with the conventional functional components without hindering deformation of a tire. An aspect of the present disclosure includes a housing 110 bonded to an inner peripheral surface Ti of a tire T via an elastic adhesive EA, and a recess portion 111c provided on an end surface 111e of the housing 110 facing the inner peripheral surface Ti of the tire T. The strain detection device 100 includes the strain detection element 120 that is disposed at the center part of the recess portion 111c and detects strain of the tire T via the elastic adhesive EA, and the elastic member 130 that is disposed in the inner peripheral edge part of the recess portion 111c and protrudes toward the inner peripheral surface Ti of the tire T relative to the end surface 111e of the housing 110. The elastic adhesive EA is filled in a space between the bottom surface 111b of the recess portion 111c and the inner peripheral surface Ti of the tire T inside the elastic member 130.

### TECHNICAL FIELD

The present disclosure relates to a strain detection device.

### BACKGROUND ART

Conventionally, a functional component attachable to a tire is known. The functional component described in PTL 1 below houses an electronic component that can acquire information of a tire and may be attached to a tire inner peripheral surface. The functional component comprises: a housing part; a housing; strain detecting means; a support part; and an elastic part (Abstract and the like).

The housing part houses an electronic component. The housing has a bottom surface facing the tire inner peripheral surface. The strain detecting means is provided on the bottom surface of the housing and detects a strain of the tire. The support part extends from the bottom surface of the housing to the tire inner peripheral surface and protrudes farther than a surface of the strain detecting means. The elastic part is formed of an elastomer having rigidity smaller than that of a material forming the support part, the elastic part disposed between the bottom surface of the housing and the tire inner peripheral surface.

According to this configuration, by providing the support part on the bottom surface of the housing, the support part can support the functional component even if centrifugal force due to rotation of the tire acts on the functional component. As a result, the distance between the tire inner surface and the strain detecting means can be maintained constant, and variations in detection accuracy by the strain detecting means can be reduced (PTL 1, paragraph 0005, and the like).

Similarly to the functional component described above, the functional component described in PTL 2 below houses an electronic component which can acquire information in a tire, may be attached to an inner peripheral surface of the tire, and includes: a housing; and a cylindrical part (Abstract and the like). This housing has a housing part of the electronic component and a bottom surface facing the inner peripheral surface of the tire, and the cylindrical part extends from a peripheral edge of the bottom surface of the housing toward the inner peripheral surface of the tire.

According to this configuration, it is possible to fill an adhesive in a container of one opening including the housing and the cylindrical part extending from the peripheral edge of the bottom surface of the housing toward the inner peripheral surface of the tire, place the cylindrical part side on the tire surface, and then cure the adhesive. This makes it possible to bond the functional component to the tire inner surface while securing the thickness of the adhesive (PTL 2, paragraph 0005).

### CITATION LIST

### Patent Literature

PTL 1: JP 2021-146875 A
PTL 2: JP 2020-055402 A

### SUMMARY OF INVENTION

### Technical Problem

In the functional component of PTL 1, the housing is formed of a synthetic resin or the like from the viewpoint of weight reduction and strength (paragraph 0011). Therefore, the support part extending from the bottom surface of the housing to the tire inner peripheral surface becomes harder than the tire, deformation of the tire is hindered by the support part in contact with the inner peripheral surface of the tire, and the detection accuracy of the strain detecting means may be deteriorated.

In the functional component of PTL 2, the material of a skirt as the cylindrical part is an elastic material or a flexible material made of rubber, elastomer, or the like (paragraph 0010 and paragraph 0021). In this functional component, the cylindrical part is deformed following the strain of the tire, and therefore the deformation of the tire is not hindered, and the deterioration of the detection accuracy of the strain sensor can be suppressed, but further downsizing and improvement of the strain detection accuracy are required.

The present disclosure provides a strain detection device capable of downsizing and improvement in strain detection accuracy as compared with the conventional functional components without hindering deformation of a tire.

### Solution to Problem

An aspect of the present disclosure is a strain detection device including: a housing bonded to an inner peripheral surface of a tire via an elastic adhesive; a recess portion provided on an end surface of the housing facing the inner peripheral surface of the tire; a strain detection element that is disposed in a center part of the recess portion and detects strain of the tire via the elastic adhesive; and an elastic member disposed on an inner peripheral edge part of the recess portion and protruding toward the inner peripheral surface of the tire relative to the end surface of the housing, in which a space between a bottom surface of the recess portion and the inner peripheral surface of the tire inside the elastic member is filled with the elastic adhesive.

### Advantageous Effects of Invention

According to the aspect of the present disclosure, it is possible to provide a strain detection device capable of downsizing and improvement in strain detection accuracy as compared with the conventional functional components without hindering deformation of a tire.

### BRIEF DESCRIPTION OF DRAWINGS

FIG. 1 is an enlarged cross-sectional view illustrating an embodiment of a strain detection device according to the present disclosure.

FIG. 2 is a bottom view of the strain detection device of FIG. 1.

FIG. 3 is an enlarged view of a part III surrounded by a dash-dotted line of a rectangle in FIG. 1.

### DESCRIPTION OF EMBODIMENTS

Hereinafter, an embodiment of the strain detection device according to the present disclosure will be described with reference to the drawings.

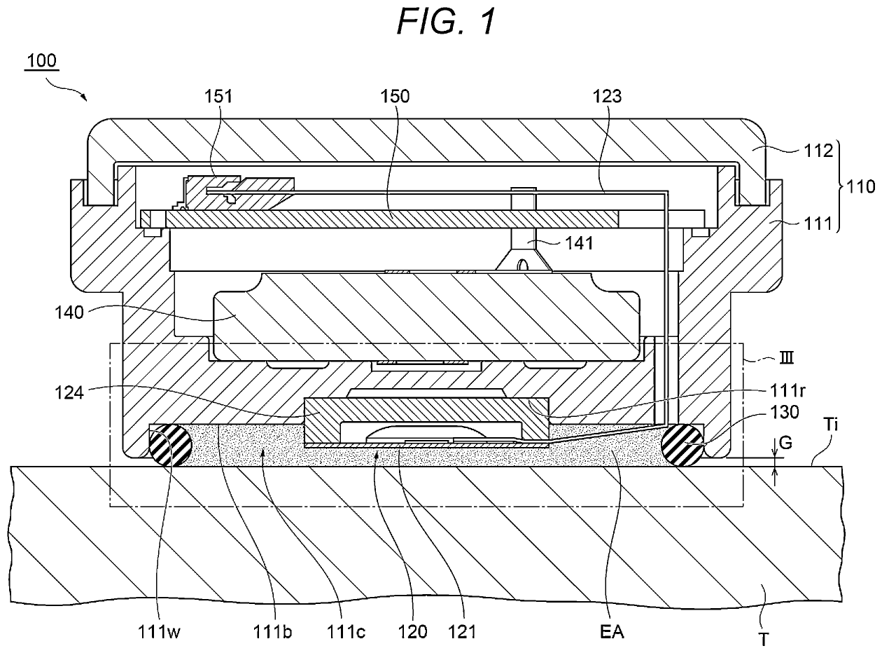

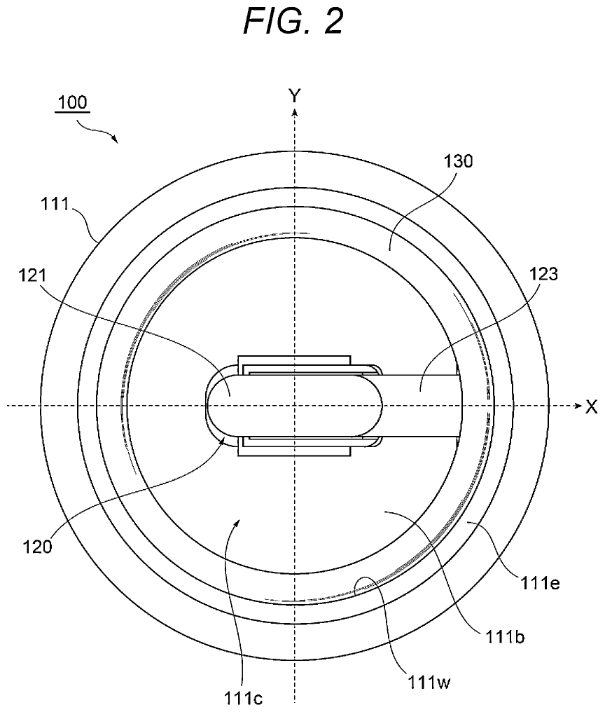

FIG. 1 is an enlarged cross-sectional view illustrating an embodiment of the strain detection device according to the present disclosure. FIG. 2 is a bottom view of a strain detection device 100 of FIG. 1. The strain detection device 100 of the present embodiment is a device that is attached to an inner peripheral surface Ti of a tire T of a vehicle such as an automobile, for example, detects strain of the tire T, and transmits a detection result to an external device such as a vehicle control device mounted on the vehicle by wireless communication.

The strain detection device 100 of the present embodiment mainly includes a housing 110, a strain detection element 120, and an elastic member 130. In the example illustrated in FIG. 1, the strain detection device 100 further includes a battery 140 and a circuit board 150. Each part of the strain detection device 100 of the present embodiment will be described below in detail.

The housing 110 is a bottomed cylindrical member that accommodates components such as the battery 140 and the circuit board 150, for example, and is bonded to the inner peripheral surface Ti of the tire T via an elastic adhesive EA. The hardness of the elastic adhesive EA after curing is equivalent to the hardness of the tire T. The elastic adhesive EA has elasticity capable of elastically deforming following deformation of the tire T when the vehicle travels, for example.

The housing 110 is a molded product of synthetic resin harder than the hardness of the tire T, for example. The housing 110 has a cylindrical shape in which the diameter of the upper end part positioned on the center side of the tire T is larger than the diameter of the lower end part adjacent to the inner peripheral surface Ti of the tire T, for example. The shape of the housing 110 is not limited to a cylindrical shape, and any shape such as an elliptical cylindrical shape, a rectangular tubular shape, or a polygonal tubular shape can be adopted.

The housing 110 includes a body part 111 having a bottomed cylindrical shape having an opening part, for example, and a lid part 112 having a flat plate shape that closes the opening part of the body part 111. For example, a recess groove for engaging a peripheral edge part of the lid part 112 is provided around the opening part provided at the upper end of the body part 111 positioned on the center side of the tire T. The peripheral edge part of the lid part 112 is provided so as to protrude toward the inner peripheral surface Ti of the tire T in a radial direction of the tire T, which is the height direction of the strain detection device 100, for example, and is engaged with the recess groove of the upper end part of the body part 111. The lid part 112 is joined to the body part 111 with an adhesive, for example, and seals the opening part of the body part 111.

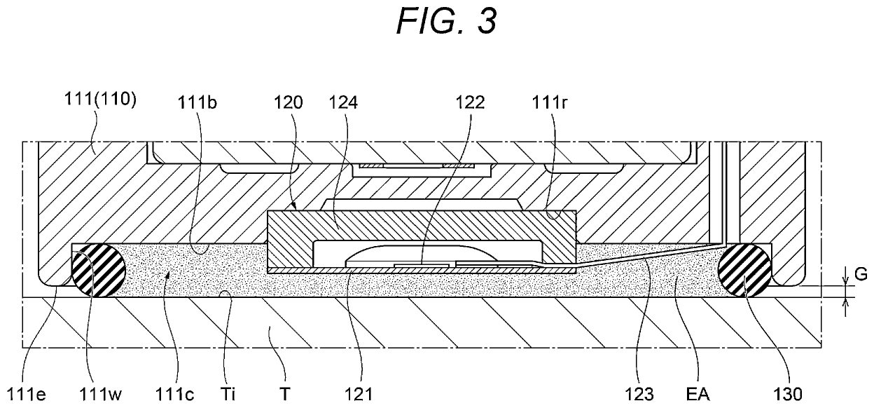

FIG. 3 is an enlarged view of a part III surrounded by the dash-dotted line in FIG. 1, that is, a lower end part of the body part 111 of the housing 110. A recess portion 111c is provided on an end surface 111e facing the inner peripheral surface Ti of the tire T at the lower end part of the body part 111. The recess portion 111c is provided in a part excluding a peripheral edge part of the end surface 111e of the body part 111, for example.

In place of the configuration in which the recess portion 111c is provided in the end surface 111e of the body part 111, a protrusion portion may be provided in the peripheral edge part of the end surface of the body part 111 facing the inner peripheral surface Ti of the tire T, a tip end surface of the protrusion portion may be the end surface 111e, and an inside of the protrusion portion may be the recess portion 111c. In this case, the protrusion portion around the recess portion 111c may be continuous over the entire periphery of the recess portion 111c, or may be partially provided around the recess portion 111c.

The recess portion 111c provided in the end surface 111e of the body part 111 has a bottom surface 111b orthogonal to the height direction of the strain detection device 100, for example, and an inner peripheral wall 111w parallel to the height direction of the strain detection device 100. The inner peripheral wall 111w is provided continuously over the entire periphery of the bottom surface 111b, for example. For example, the elastic member 130 is disposed on the outer edge part of the bottom surface 111b of the recess portion 111c, and the center part of the bottom surface 111b of the recess portion 111c is provided with a holding recess portion 111r for holding the strain detection element 120.

The strain detection element 120 is a device that is disposed in the center part of the recess portion 111c provided in the end surface 111e of the body part 111 and detects strain of the tire T via the elastic adhesive EA. The strain detection element 120 includes a support member 121 having a flat plate shape, for example, and semiconductor sensor 122. The strain detection element 120 includes, for example, a wire 123 and an elastic support member 124.

The support member 121 is supported by the bottom surface 111b of the recess portion 111c of the housing 110 and faces the inner peripheral surface Ti of the tire T via the elastic adhesive EA. More specifically, the support member 121 is bonded to the end surface of the elastic support member 124 held in the holding recess portion 111r provided in the center part of the bottom surface 111b of the recess portion 111c, for example, and is supported by the bottom surface 111b of the recess portion 111c via the elastic support member 124. The support member 121 is, for example, a thin metal plate such as stainless steel having a thickness of about 0.3 mm. The lower surface of the support member 121 facing the inner peripheral surface Ti of the tire T via the elastic adhesive EA is a flat surface having no unevenness, for example.

The semiconductor sensor 122 is provided on an upper surface of the support member 121 opposite to a lower surface facing the inner peripheral surface Ti of the tire T. The semiconductor sensor 122 is a semiconductor chip having a square shape, for example. Note that the shape of the semiconductor chip is not limited to a square shape, and may be a circular shape, an elliptical shape, or other shapes. The semiconductor sensor 122 uses, for example, a piezoresistive effect of diffusion resistance formed by ion-implanting impurities into a silicon single crystal, and can detect strain of the tire T by directly measuring a voltage from an electrode pad of the semiconductor chip. More specifically, the semiconductor sensor 122 detects strain of the tire T by detecting strain of the support member 121 that deforms following deformation of the tire T, for example.

The semiconductor sensor 122 is a semiconductor sensor for biaxial strain measurement that detects strain in two directions orthogonal to each other, for example. For example, as illustrated in FIG. 2, the semiconductor sensor 122 measures strain components in each of an X axis direction, which is a peripheral direction of the tire T, i.e., a rotation direction, and a Y axis direction, which is a width direction of the tire T. Therefore, the semiconductor sensor 122 includes two bridge circuits of a diffusion resistance in one sensor chip, and calculates a strain component in each direction from output values of these bridge circuits.

The two bridge circuits capable of detecting strain in two directions orthogonal to each other are bridge circuits in which two diffusion resistances of two types, that is, a high-sensitivity resistance, which is a diffusion resistance with high strain sensitivity, and a low-sensitivity resistance, which is a diffusion resistance with low strain sensitivity, are combined, for example. As the high-sensitivity resistance, a diffusion resistance having a large difference in absolute value of the strain sensitivity in the parallel direction and the vertical direction with respect to the current is used. This can increase the difference between the absolute values of the strain sensitivities in the long direction and the short direction in the two bridge circuits, and enables measurement of the strain in the two directions orthogonal to each other.

The wire 123 connects the semiconductor sensor 122 and the circuit board 150, for example. The wire 123 includes a power supply line that supplies power from the circuit board 150 to the semiconductor sensor 122, and a signal line that transmits a signal output from the semiconductor sensor 122 to the circuit board 150, for example. The wire 123 is drawn out from the semiconductor sensor 122, for example, passed through a through hole provided in a bottom wall of the body part 111 of the housing 110, and connected to a connector 151 of the circuit board 150 accommodated in the housing 110.

The elastic support member 124 has a recess portion forming a space for accommodating the semiconductor sensor 122, for example, and the support member 121 is bonded to an end surface provided with the recess portion. The end surface of the elastic support member 124 opposite to the end surface to which the support member 121 is bonded is bonded to the holding recess portion 111r provided in the center part of the recess portion 111c of the body part 111 by an adhesive, for example. As a material of the elastic support member 124, for example, an elastic material having hardness equivalent to the hardness of the tire T, such as silicone rubber, can be used. The elastic support member 124 absorbs vibration and impact acting on the strain detection element 120, for example, and protects the semiconductor sensor 122 from vibration and impact.

The elastic member 130 is disposed in an inner peripheral edge part of the recess portion 111c provided in the body part 111 of the housing 110, and protrudes toward the inner peripheral surface Ti of the tire T relative to the end surface 111e of the body part 111. Then, the elastic adhesive EA is filled in a space between the bottom surface 111b of the recess portion 111c of the body part 111 and the inner peripheral surface Ti of the tire T inside the elastic member 130.

Due to this, a gap G is formed between the end surface 111e of the body part 111 of the housing 110 and the inner peripheral surface Ti of the tire T in a state where the housing 110 is bonded to the inner peripheral surface Ti of the tire T via the elastic adhesive EA. The height at which the elastic member 130 protrudes from the end surface 111e of the body part 111 in the height direction of the strain detection device 100 is determined in accordance with the height of the gap G capable of avoiding contact between the inner peripheral surface Ti of the tire T and the housing 110 when the tire T is deformed, for example.

The elastic member 130 has an shape as illustrated in FIG. 2, for example, and the semiconductor sensor 122 for biaxial strain measurement constituting the strain detection element 120 is disposed at the center of the elastic member 130 having the annular shape. For example, as illustrated in FIGS. 1 and 3, the elastic member 130 has a circular cross-sectional shape in a cross section along the radial direction of the elastic member 130 having the annular shape.

Note that the shape of the elastic member 130 is not limited to the annular shape. For example, as illustrated in FIG. 2, the shape of the elastic member 130 may be an oval shape corresponding to the support member 121 having an oval shape of the strain detection element 120. The shape of the elastic member 130 can be a shape similar to the shape of the semiconductor chip of the semiconductor sensor 122 such as a square, for example. In these cases, the shape of the recess portion 111c of the body part 111 is also changed in accordance with the shape of the elastic member 130. The cross-sectional shape of the cross section of the elastic member 130 is not limited to a circular shape. As the cross-sectional shape of the cross section of the elastic member 130, for example, an elliptical shape, a quadrangular shape, a D shape having a semicircular outer peripheral side, or other shapes can be adopted.

The outer edge of the elastic member 130 is engaged with the inner peripheral wall 111w of the recess portion 111c provided in the body part 111 of the housing 110. That is, the elastic member 130 having the annular shape is fitted inside the inner peripheral wall 111w of the recess portion 111c in a state of being elastically deformed radially inward, for example. Due to this, the outer edge of the elastic member 130 is pressed against the inner peripheral wall 111w of the recess portion 111c by the elastic force of the elastic member 130.

The material of the elastic member 130 is an elastic material such as rubber similar to the material of the tire T, for example. The elastic member 130 has hardness equivalent to the hardness of the tire T, for example. The hardness of the elastic member 130 is about 50 to 80 in Shore A durometer hardness, for example. Note that the elastic member 130 and the housing 110 may be separate members formed individually, or may be a single member formed integrally.

The battery 140 is, for example, a button-type battery, is accommodated inside the body part 111 from an opening part of the body part 111 of the housing 110, and is disposed and held in a recess portion provided in a bottom wall of the body part 111. The battery 140 is connected to the circuit board 150 via a connection terminal 141, for example, and supplies power to the circuit board 150.

The circuit board 150 is accommodated inside the opening part of the body part 111 of the housing 110, for example, and is disposed on the battery 140. The peripheral edge part of the circuit board 150 is fixed to a step portion inside the opening part of the body part 111, for example. The circuit board 150 includes a connector 152 to which the wire 123 of the strain detection element 120 is connected, for example, supplies power to the strain detection element 120, and receives a detection result of the strain of the tire T from the strain detection element 120.

The circuit board 150 includes, for example, a power supply circuit, a signal processing circuit, a wireless communication circuit, and a control circuit. The power supply circuit supplies power supplied from the battery 140, for example, to the strain detection element 120. The signal processing circuit processes a signal input from the strain detection element 120, for example. The wireless communication circuit transmits a detection result of the strain of the tire T by the strain detection element 120, for example, to an external device by wireless communication. The control circuit controls, for example, the power supply circuit, the signal processing circuit, and the wireless communication circuit.

Hereinafter, the operation of the strain detection device 100 of the present embodiment will be described on the basis of comparison with the conventional technique.

In the functional component described in PTL 1 described above, the housing is formed of a synthetic resin or the like from the viewpoint of weight reduction and strength (paragraph 0011). Therefore, the support part extending from the bottom surface of the housing to the tire inner peripheral surface becomes harder than the tire, deformation of the tire is hindered by the support part in contact with the inner peripheral surface of the tire, and the detection accuracy of the strain detecting means may be deteriorated.

On the other hand, in the functional component of PTL 2, the material of a skirt as the cylindrical part is an elastic material or a flexible material made of rubber, elastomer, or the like (paragraph 0010 and paragraph 0021). In this functional component, the cylindrical part is deformed following the strain of the tire, and therefore the deformation of the tire is not hindered, and the deterioration of the detection accuracy of the strain sensor can be suppressed, but further downsizing and improvement of the strain detection accuracy are required.

Specifically, in the functional component of PTL 2 described above, the skirt is attached to a skirt attachment portion on the outer peripheral surface of the housing case (paragraph 0017, FIG. 4, and the like). The skirt includes an annular cylindrical portion and an enlarged portion extending from the cylindrical portion toward the inner peripheral surface of the tire (paragraph 0018, FIG. 4, and the like). The enlarged portion is formed in a fan shape continuous from the cylindrical portion. The inner peripheral surface of the enlarged portion is formed as a curved surface gradually increasing in diameter from the outer peripheral edge of the outer bottom surface of the housing case toward the inner peripheral surface side of the tire in the axial cross section (paragraph 0019, FIG. 4, and the like).

In such a configuration, the outer diameter of the enlarged portion of the skirt is larger than the outer diameter of the housing case, which not only increases the size of the functional component but also increases the amount of adhesive filled inside the skirt. The thicknesses of the inner peripheral surface and the outer peripheral surface forming the enlarged portion are set to be tapered so as to gradually decrease toward the axial end part on the inner peripheral surface side of the tire (paragraph 0020 and FIG. 4).

Therefore, in the functional component of PTL 2 described above, the rigidity of the tip end part of the skirt on the inner peripheral surface side of the tire is deteriorated, and there is a possibility that the functional component is bonded to the inner peripheral surface of the tire with the adhesive in a state where the center line in the height direction is inclined with respect to the radial direction of the tire. In this case, the thickness of the adhesive between the strain sensor attached to the outer bottom surface of the housing and the inner peripheral surface of the tire becomes non-uniform, and the strain detection accuracy of the tire may be deteriorated (paragraph 0044 and FIGS. 10(b) and (c)).

On the other hand, the strain detection device 100 of the present embodiment includes the housing 110 bonded to the inner peripheral surface Ti of the tire T via the elastic adhesive EA, and the recess portion 111c provided on the end surface 111e of the housing 110 facing the inner peripheral surface Ti of the tire T. The strain detection device 100 includes the strain detection element 120 that is disposed at the center part of the recess portion 111c and detects strain of the tire T via the elastic adhesive EA, and the elastic member 130 that is disposed in the inner peripheral edge part of the recess portion 111c and protrudes toward the inner peripheral surface Ti of the tire T relative to the end surface 111e of the housing 110. Then, in the strain detection device 100, the elastic adhesive EA is filled in a space between the bottom surface 111b of the recess portion 111c and the inner peripheral surface Ti of the tire T inside the elastic member 130.

With such a configuration, the strain detection device 100 is brought into a state of being in contact with the tire T via the elastic member 130 and the elastic adhesive EA filled in the space inside thereof in a state where the housing 110 is bonded to the inner peripheral surface Ti of the tire T via the elastic adhesive EA. Due to this, when the tire T elastically deforms, the elastic member 130 and the elastic adhesive EA having hardness equivalent to that of the tire T, for example, elastically deform following the elastic deformation of the tire T.

The gap G is formed between the end surface 111e of the housing 110 and the inner peripheral surface Ti of the tire T by the elastic member 130 protruding toward the inner peripheral surface Ti of the tire T relative to the end surface 111e of the housing 110. This can prevent the elastic deformation of the tire T from being hindered by the housing 110 of the strain detection device 100 and improve the detection accuracy of strain of the tire T by the strain detection element 120. Since the elastic member 130 and the elastic adhesive EA elastically deform following the elastic deformation of the tire T, concentration of stress on the elastic adhesive EA is prevented, and the strain detection device 100 can be prevented from peeling off from the inner peripheral surface Ti of the tire T.

Furthermore, by filling the elastic adhesive EA in the space between the bottom surface 111b of the recess portion 111c and the inner peripheral surface Ti of the tire T inside the elastic member 130, the thickness of the elastic adhesive EA between the strain detection element 120 and the inner peripheral surface Ti of the tire T becomes uniform. Due to this, the distribution of the strain detected by the strain detection element 120 via the elastic adhesive EA becomes uniform, and the detection sensitivity of the strain of the tire T via the elastic adhesive EA by the strain detection element 120 becomes uniform. Therefore, the strain detection accuracy of the tire T by the strain detection element 120 can be improved.

With the above configuration, the strain detection device 100 can dispose the elastic member 130 inside the recess portion 111c provided on the end surface 111e of the housing 110 facing the inner peripheral surface Ti of the tire T. Therefore, the strain detection device 100 of the present embodiment can be downsized as compared with a configuration in which a skirt extending from a peripheral edge of the bottom surface of the housing toward the inner peripheral surface of the tire includes an enlarged portion as in a functional component described in PTL 2. According to the strain detection device 100 of the present embodiment, the usage amount of the elastic adhesive EA can be reduced and the material cost can be reduced as compared with the functional component described in PTL 2.

In the strain detection device 100 of the present embodiment, the elastic member 130 has an annular shape. The strain detection element 120 includes the semiconductor sensor 122 for biaxial strain measurement that detects strain in two directions orthogonal to each other, and is disposed at the center of the elastic member 130 having the annular shape.

With such a configuration, the strain detection device 100 of the present embodiment can uniformly detect strain of the tire T in all radial directions of the elastic member 130 having the annular shape by the strain detection element 120 via the elastic adhesive EA. Due to this, the deformation state of the tire T can be more accurately detected by the strain detection element 120, and for example, information on unevenness or the like of a road surface on which the vehicle travels can be more accurately grasped. In the strain detection device 100 of the present embodiment, the elastic member 130 has a circular cross-sectional shape in a cross section.

With such a configuration, the strain detection device 100 of the present embodiment can bring the contact between the elastic member 130 and the bottom surface 111b and the inner peripheral wall 111w of the recess portion 111c of the housing 110 and the contact between the elastic member 130 and the inner peripheral surface Ti of the tire T close to line contact. Due to this, the elastic member 130 can be stably supported by the bottom surface 111b and the inner peripheral wall 111w at the inner peripheral edge part of the recess portion 111c.

By bringing the contact between the elastic member 130 and the bottom surface 111b of the recess portion 111c and the contact between the elastic member 130 and the inner peripheral surface Ti of the tire T close to line contact, the height of the elastic member 130 between them can be made uniform in the peripheral direction of the elastic member 130. Due to this, the thickness of the elastic adhesive EA between the bottom surface 111b of the recess portion 111c and the inner peripheral surface Ti of the tire T can be made uniform, and the strain detection accuracy of the strain detection device 100 can be improved. When the cross-sectional shape of the cross section of the elastic member 130 is elliptical, the compressive strength in the major axis direction of the elliptical cross section can be improved.

In the strain detection device 100 of the present embodiment, the outer edge of the elastic member 130 is engaged with the inner peripheral wall 111w of the recess portion 111c.

With such a configuration, the strain detection device 100 of the present embodiment can support the outer edge of the elastic member 130 by the inner peripheral wall 111w of the recess portion 111c and hold the elastic member 130 inside the recess portion 111c. Therefore, it is not necessary to provide a protrusion portion for engaging the elastic member 130 with the bottom surface 111b of the recess portion 111c inside the elastic member 130, and it is possible to prevent the strain detection accuracy of the strain detection element 120 from deteriorating due to the protrusion portion harder than the tire T.

In the strain detection device 100 of the present embodiment, the strain detection element 120 includes the support member 121 having the flat plate shape and the semiconductor sensor 122. The support member 121 is supported by the bottom surface 111b of the recess portion 111c of the housing 110 and faces the inner peripheral surface Ti of the tire T via the elastic adhesive EA. The semiconductor sensor 122 is provided on a surface of the support member 121 opposite to a surface facing the inner peripheral surface Ti of the tire T.

With such a configuration, in the strain detection device 100 of the present embodiment, the surface of the support member 121 facing the inner peripheral surface Ti of the tire T can be a flat surface having no unevenness. This can prevent a protrusion portion harder than the tire T from being formed on the surface of the support member 121 facing the inner peripheral surface Ti of the tire T and prevent the strain detection accuracy of the strain detection element 120 from deteriorating. The semiconductor sensor 122 can detect the strain of the tire T with high accuracy via the elastic adhesive EA having a uniform thickness and the support member 121 having the flat plate shape.

Although the embodiment of the strain detection device according to the present disclosure has been described in detail with reference to the drawings, the specific configuration is not limited to this embodiment, and design changes and the like without departing from the gist of the present disclosure are included in the present disclosure.

### REFERENCE SIGNS LIST

100 strain detection device
110 housing
111 body part (housing)
111b bottom surface
111c recess portion
111e end surface
111w inner peripheral wall
112 lid part (housing)
120 strain detection element
121 support member
122 semiconductor sensor (semiconductor sensor for biaxial strain measurement)
130 elastic member
EA elastic adhesive
T tire
Ti inner peripheral surface

1. A strain detection device comprising:
a housing bonded to an inner peripheral surface of a tire via an elastic adhesive;
a recess portion provided on an end surface of the housing facing the inner peripheral surface of the tire;
a strain detection element that is disposed in a center part of the recess portion and detects strain of the tire via the elastic adhesive; and
an elastic member disposed on an inner peripheral edge part of the recess portion and protruding toward the inner peripheral surface of the tire relative to the end surface of the housing,
wherein a space between a bottom surface of the recess portion and the inner peripheral surface of the tire inside the elastic member is filled with the elastic adhesive.

2. The strain detection device according to claim 1, wherein
the elastic member has an annular shape, and
the strain detection element includes a semiconductor sensor for biaxial strain measurement that detects strain in two directions orthogonal to each other, and is disposed at a center of the elastic member having the annular shape.

3. The strain detection device according to claim 1, wherein the elastic member has a circular cross-sectional shape in a cross section.

4. The strain detection device according to claim 1, wherein an outer edge of the elastic member is engaged with an inner peripheral wall of the recess portion.

5. The strain detection device according to claim 1, wherein
the strain detection element includes
a support member having a flat plate shape supported by the bottom surface of the recess portion of the housing and facing the inner peripheral surface of the tire via the elastic adhesive, and
a semiconductor sensor provided on a surface of the support member opposite to a surface facing the inner peripheral surface of the tire.
